(19) United States
(12) Patent Application Publication
(10) Pub. No.: US 2008/0116330 A1
(43) Pub. Date: May 22, 2008

(54) Apparatus for leveling and method of using same

(76) Inventor: Peter J. Cotto, Houston, TX (US)

Correspondence Address: THE MATTHEWS FIRM, 2000 BERING DRIVE, SUITE 700, HOUSTON, TX, 77057, US

(21) Appl. No.: 12/009,246

(22) Filed: Jan. 17, 2008

Related U.S. Application Data
(63) Continuation-in-part of application No. 11/009,564, filed on Dec. 10, 2004, now abandoned.

(51) Int. Cl. F16M 11/24

(52) U.S. Cl. 248/188.4

(57) ABSTRACT

A device for leveling a desired object such as a cabinet or enclosure on uneven or sloping floors is provided. The device comprises a housing which may be attached to the object to be leveled, such as a cabinet wall, either prior to, or during installation of the cabinet, enclosure, or other desired object. The housing is further provided with a threaded hole and a threaded member which engages the threaded hole. When the treaded member is rotated, it will contact the uneven or sloping floor and can lift or lower the cabinet or enclosure as needed for leveling.

### RELATED APPLICATIONS

This application is a continuation-in-part of U.S. patent application Ser. No. 11/009,564, filed Dec. 10, 2004.

### TECHNICAL FIELD

This invention relates generally to a leveling apparatus and more particularly to a leveling device for leveling prefabricated or custom cabinetry without the use of shims.

### BRIEF BACKGROUND OF THE INVENTION

The need to install and level objects on uneven or sloping floors has presented a long-standing problem, especially for various types of apparatuses including machines and appliances. Often floors are not plumb or perfectly flat, yet it is important that all the legs or supports of an object contact the floor to provide adequate support and to equally distribute the weight of the object. If all the legs do not contact the floor, many problems can develop. For example, the outer cabinet and frame of an apparatus may become distorted over time due to nonuniform weight support, thereby impairing the proper operation of the apparatus. Annoying “rocking” problems with an apparatus may also result where the legs do not all contact the floor. Moreover, installations that are not level may be aesthetically undesirable by the inability to match the heights of adjacent cabinets, other equipment, or work surfaces.

Installers and manufacturers have attempted to resolve the leveling problem by developing approaches to compensate for uneven and sloping floors. Where the height of apparatus legs is not adjustable, for example, one such approach used by installers has been to place shims or wedges made of a suitable material under the legs. Obviously, this technique has numerous drawbacks. First, the apparatus must be manually lifted while such shims are placed under the legs, thereby often requiring more than one installer. This situation also increases the potential risk of back or other physical injuries to the installers. Second, the shims are not permanently mounted to the apparatus legs and may shift over time or become completely dislodged.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers.

FIG. 1 is an elevation pictorial view of a cabinet employing the leveling apparatus according to the present invention;

FIG. 2 illustrates a leveling apparatus according to the present invention;

FIG. 3 is an elevation pictorial closeup view of the embodiment illustrated in FIG. 1;

FIG. 4 is a top view of a cabinet or other structure having plugs for covering the access hole for the leveling apparatus according to the present invention; and

FIG. 4A is a side elevation view of the embodiment illustrated in FIG. 4 according to the present invention;

FIG. 5 illustrates a leveling apparatus according to the present invention;

FIG. 6 is a side elevation view of the embodiment illustrated in FIG. 5 according to the present invention.

### DETAILED DESCRIPTION OF EMBODIMENTS OF THE INVENTION

Manufacturers have attempted to resolve the leveling problem with numerous design approaches. One technique which has been employed is to provide manually adjustable legs or supports, often referred to commercially as glides or levelers, under each corner of the apparatus's outer cabinet. This consists primarily of a threaded vertical rod which on one end is screwed into a female threaded coupling near the apparatus's corners. The rod typically has a pad or flattened base of some sort disposed on the opposite end which contacts the floor. The pad may also swivel or tilt relative to the longitudinal axis of the vertical rod. These manually adjustable supports, however, are still plagued by many of the problems encountered with the shim technique described above. For example, in many cases, the apparatus must be lifted manually to unload weight from the legs in order to rotate them and adjust their height. Furthermore, there is usually no way to access the rear legs for adjustment once the apparatus is slid into its final position because access is often not available from the rear or sides of the apparatus. This is particularly true of kitchen appliances and cabinets which are usually placed against a wall in the rear and have other equipment, cabinets, or a wall positioned against one or both sides of the apparatus or cabinet. The manually adjustable leg design is also cumbersome to use, involving a time consuming trial and error approach to leveling the apparatus on uneven floors. The apparatus must often be slid into and out of its final position numerous times while gradual adjustments are made to the otherwise inaccessible rear support legs in hopes of finding the proper height of each rear leg. Other approaches have included manually adjustable wheels or rollers for rear supports and rear leveling systems which adjustable from the front.

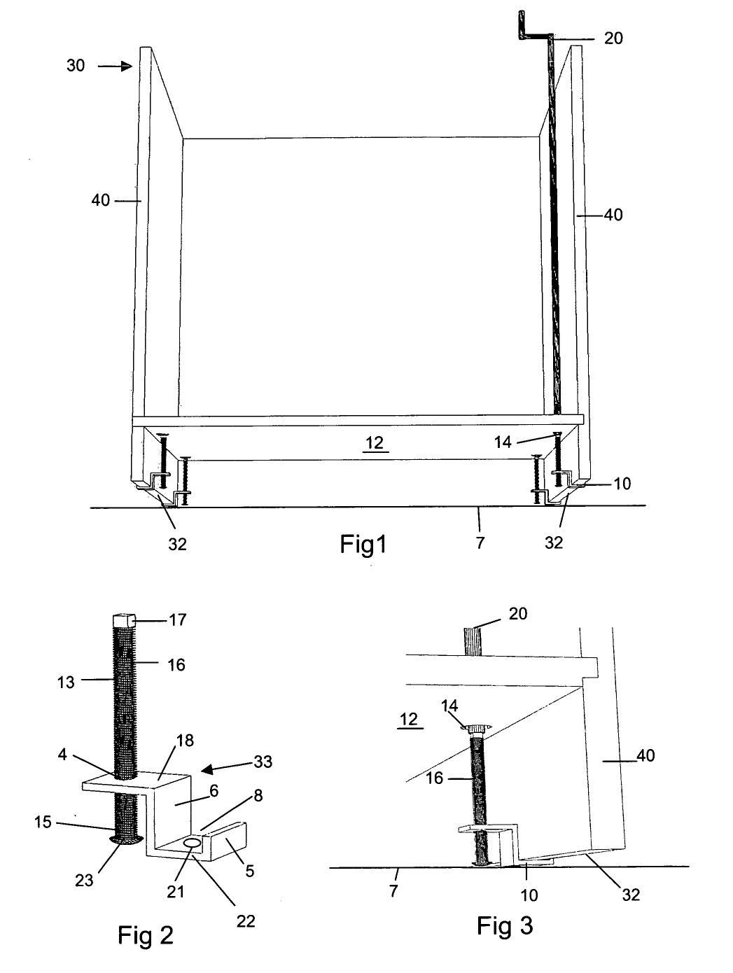

FIG. 1 illustrates the leveling apparatus 10 attached to an enclosure 30. It should be understood by those in the art that the leveling apparatus 10 may or may not actually comprise a bubble level to indicate exactly when an enclosure, cabinet, or other desired object 30 is level. In one embodiment, a separate level indicator may be required to assure that a particular cabinet 30 or cabinet surface is level. However, the leveling apparatus 10 is preferably utilized to position the attached enclosure, cabinet, or other desired object 30 so as to establish a level position with respect to some predetermined support surface or floor 7. It should be appreciated that enclosure 30 can be a variety of enclosures, such as cabinets, appliance stands, entertainment centers, computer stands, toy boxes, enclosures for clothing or household goods, appliances, appliance enclosures, and any variety of enclosures which may typically be set up against a wall or in a room for storage. It should be further appreciated that the leveling apparatus 10 may be used to level tables, various counter tops, shelves, and the like and in such applications the accessibility of the leveling apparatus 10 may be easier. It should be noted that this cabinetry, whether custom made or purchased in an assembled or semi-assembled state, can be installed into homes either during building, remodeling, or anytime someone wishes to install extra storage space. As described herein above, because floors 7 or support members for such enclosures or cabinets 30 are frequently unlevel, it is necessary to have a leveling device which preferably has easy access. Preferably, the leveling apparatus 10 attaches as illustrated in FIG. 1 around or to a bottom edge or rim 32 of the enclosure or cabinet 30. However, the leveling apparatus 10 may also be configured to mount to any support surface.

The leveling apparatus 10 is preferably installed prior to completing the assembly of the cabinets or enclosures 30, and still more preferably, before the cabinet or enclosure 30 is set in its right side up position. Unlike prior art devices, this leveling apparatus 10 is designed for an interference fit with the cabinetry 30 or other enclosure. In one embodiment, this tight fit requires the leveling apparatus 10 to be tapped on with a hammer or other tool. Once tapped into position, the leveling apparatus 10 firmly grips the sides of the cabinetry 30 and resists sliding off the cabinetry 30 and along the edge of the cabinetry 30. This configuration provides an advantage during installation and throughout the life of the cabinetry 30. During construction or installation the cabinetry 30 can be lifted or turned in any required orientation and each leveling apparatus 10 will remain securely gripped in place. Once the cabinetry or other enclosure 30 has been completed or installed, the grip of the leveling apparatus 10 will allow the object to be lifted or moved without upsetting the locations of any leveling apparatus 10 attached thereto. Thus, the leveling apparatus 10 is easily installed.

It should be understood that when cabinetry, particularly custom made cabinetry, is installed, typically there is no access from the outside or face boards to the leveling apparatus 10. Therefore, preferably leveling apparatus 10 is accessed through the sub-floor or bottom shelf 12 of cabinet 30. Preferably, and as illustrated in FIG. 1, leveling apparatus 10 is installed around or near the corners of the cabinet or enclosure 30. It should be appreciated by those in the art that when cabinets or enclosure 30 are considerably longer than they are wide, leveling supports 10 placed along the longitudinal side of enclosure 30, would be spaced as required to maintain the enclosure 30 level. Preferably, leveling apparatus 10 can be accessed through the sub-floor or bottom shelf 12 through a series of holes 14 drilled through the sub-floor or shelf 12 providing access to the top 17 (see FIG. 3) of leveling apparatus 10. It should be understood by those in the art how to form the holes 14 above the leveling apparatus 10, and as such, will not be described further herein.

FIG. 2 illustrates an embodiment of the leveling apparatus 10. Preferably, the leveling apparatus 10 comprises a solid single piece threaded member 13. It should be appreciated that although the preferred embodiment utilizes a threaded member 13 to move the attached enclosure, table, or other desired object 30, member 13 can be moved utilizing other than threaded means, such as those similar to a conventional jack, a ratchet system, modified threads, actuation, or a variety of means which would allow member 13 to raise or lower enclosure or object 30. Threaded member 13 preferably contains an integrally formed bottom end 15 and a top end 17. By way of non-limiting examples, the top end 17 may comprise a square cross-sectional shape or hexagonal cross-sectional shape to allow the attachment of a wrench or socket type tool that can be used for turning threaded member 13 in a clockwise or counterclockwise direction. It should be appreciated by those in the art that the shape of the top end 17 can be of a variety of cross-sectional configurations, including square hexagonal, or other polygonal shapes. It can also have a recessed top, allowing access by a hex wrench, torx wrench, or other similar device. The top end 17 may also be configured for accepting crosshead or flathead screwdrivers, or be configured to accept any type of tool that can access the threaded member 13 and cause it to rotate.

It should be further appreciated that the bottom end 15 preferably has a substantially rounded or spherical self seating bottom surface 23 for contact with whatever structure is supporting the cabinet or enclosure 30 such as, but not limited to, a floor or support surface 7. It should be noted, however, that the exact configuration of the bottom end 15 could vary depending upon the structure upon which it rests, such as bottom end 15 may be substantially larger for a very rough area, or perhaps for certain types of carpeted areas. It should be further noted that the bottom end 15 can also have a protective covering or coating so as to prevent damage, such as scratching or gouging, from the bottom end 15 and any flooring 7 that may be supporting cabinet 30.

The substantially rounded or spherical self seating bottom surface 23 is a portion of the single piece threaded member 13 and provides several advantages over other designs. The leveling apparatus 10 is designed to be adjusted as the cabinetry 30 sits in place. As can be seen in FIG. 3, the full weight of the cabinetry or other enclosure 30, will be distributed among the leveling apparatuses 10 even as each leveling apparatus 10 is adjusted. A flat bottom surface in a single piece member for contacting the support 7 has several shortcomings overcome by the design of the present invention. A flat bottom piece integrally formed with the single member would be difficult to rotate because of the increased contact area with the presumably substantially flat support surface 7. Rotation of this substantially flat bottom surface resulting from rotation of the threaded member will also result in the bottom surface “walking” on the floor or support surface 7. “Walking” occurs when only a portion of the rigid substantially flat bottom portion is in contact with the support surface 7. For instance, the bottom portion may be substantially contacting the support surface 7 at only an edge or a lip. As the single piece threaded member and any bottom portion thereof rotates a portion, such as the edge, of the substantially flat bottom contacting the ground moves, allowing dirt, dust, sawdust or other small debris to be collected or left in piles preventing direct contact with the support surface 7. This debris separating the any flat leveling surface from the support surface can shift which may end up underneath the bottom surface of the leveling device 10. It is undesirable for the leveling apparatus to ultimately rest on top of collections of debris because the debris does not ultimately offer the support sought by the leveling apparatus 10. In contrast to the debris collected by a “walking” bottom surface, FIG. 2 illustrates a spherical self seating bottom surface 23 The spherical shape allows the bottom surface 23 to make firm contact with the support surface 7 even when the support surface 7 is not substantially flat or already contains surface indentations or imperfections. The spherical shape helps ensure the lowermost portion of the bottom surface 23 remains in contact with the support surface 7. As such, dirt and debris are typically pushed away from the contact area as the spherical bottom 23 portion of the single piece threaded member 13 seats itself in the support surface 7 during rotation.

Additionally, the rounded or spherical bottom surface 23 of the bottom portion 15 provides a support with a single piece supporting member 13. One alternative is a flat bottom surface in the form of a base pivotally connected to the threaded member. Such a swiveling configuration could improve contact with the support structure 7, but the flat bottom still rest on debris and may not conform to indentations and imperfections in the support structure. The flat bottom of neither a one piece member nor a member with a swivel connection provide the secure contact the rounded or spherical portion of the bottom portion 15 provides. The rounded or spherical bottom surface of the bottom portion 15 seats itself on flat or irregular support structures by sweeping debris away from the contact area as the member is rotated into position. The rounded surface makes excellent contact even in the presence of indentations and irregularities in the support structure. Additionally, the swivel configuration is more costly to manufacture than the single piece with the rounded or spherical bottom surface.

Referring again to FIG. 2, threaded member 13 is inserted into a clip member 33. Clip member 33 is configured to attach to a bottom end 32 of cabinet or enclosure 30. Thus, a preferred embodiment may comprise a channel 8 which is at least partially enclosed by upright wall 6 and upright wall 5 and horizontal wall 22. It should be appreciated that channel 8 must be of a width sufficient to fit on cabinet wall end 32, and may need to be sized for specific applications. In order to firmly grip the cabinet wall, the width of channel 8 is dimensioned for an interference fit. The channel 8 is dimensioned to be slightly smaller than that width of the cabinet wall. Once the leveling apparatus has been placed onto the cabinet wall 32 or even tapped onto the wall with a hammer, the slight deformation of each piece fits them tightly together. It is often desirable to attach several leveling apparatuses at the same time, which is why one would tip the cabinet over and tap each one at its desired location. The tight inference fit ensures that each leveling apparatus 10 stays where it is initially placed. It should be understood that cabinetry will typically be constructed of certain thicknesses of wood, plywood, fiberboard, etc. Therefore, the size of channel 8 will can be uniform to match typical cabinet wood thicknesses.

As illustrated in FIG. 2, another member or plate 18 is formed substantially perpendicular to channel wall 6. Plate 18 preferably has a hole 4 formed substantially in the center of plate 18. Preferably, hole 4 is internally threaded (not shown) in such a manner to accept the thread 16 of threaded member 13. Thus, as threaded member 13 is rotated in either a clockwise or counterclockwise direction, threaded member 13 advances upward or downward through hole 4. It should be understood that although the embodiment illustrated herein shows the clip member 33 as being one piece, the clip member 33 may comprise the individual components, plate 18, the upright walls 5, 6, horizontal wall 22, and the channel 8, which may be attached together in a variety of ways such as, but not limited to, welding, bolting, riveting, screwing, gluing, and other suitable attachment means.

It should be appreciated the shape of horizontal wall 22 provides a substantially flat surface along channel 8, as well as along the bottom of the clip 33. Because the ledge of a cabinet 32 is also typically flat, the flat channel 8 permits bottom end 32 of cabinet or enclosure 30 to fit tightly along each of three sides. Leveling apparatus 10 can be used to start leveling objects as low as the thickness of the clip 33 because the flat surface of horizontal wall 22 can rest on the supporting surface 7 with excellent stability. A typical, non-limiting example would be a metallic clip 33 about ⅛ inch thick. At each leveling apparatus 10 the object would be initially lifted ⅛ inch off the ground. The small rounded or spherical bottom surface of the bottom portion 15, as illustrated in FIG. 2, does not interfere with the horizontal wall 22, so the wall may be lowered into contact with the ground. The small area of the rounded or spherical bottom surface allows the hole 14 and the threaded member 13 to be placed near the upright wall 6, while still allowing the clip 33 to be adjusted so that the bottom of clip 33 rests against the support surface 7. The nearer the threaded member 13 is to upright wall 6 the less torque is placed on plate 18 by the weight of any cabinetry 30 or other objects being supported, which assists in the stability of the leveling apparatus 10.

FIG. 2 illustrates an optional screw hole 21 in the horizontal wall 22 of the clip 33. The friction fit contemplated by the embodiment illustrated in FIG. 1 can be accomplished by undersizing the width of the channel 8 by 1/64th of an inch compared to the thickness of the cabinets 40 bottom edge 32. However, some cabinetry 40 comprises wall thicknesses which are smaller than expected. For example, a particular manufacture may produce smaller than standard wall thickness by design or by not laminating both sides of the bottom edges 32 in their cabinetry 40. In order to accommodate such a situation, screw hole 21 provides an additional means for securing the clamp to cabinetry 40 independent of the clamps 33 dimensioned friction fit. In one embodiment, the screw hole 21 is countersunk in the horizontal wall 22. By way of a non-limiting example, the bottom edge 32 of a cabinet 30 rests in channel 8 and a wood screw, or other fastening means, is inserted through the screw hole 21 in to the cabinetry 30. By countersinking the screw hole 21, a wood screw, can be made flush with the bottom surface of the clip 33 while securing the bottom edge 32 of a cabinet into the channel 8. This configuration provides additional stability to the leveling apparatus 10, and ensures each leveling apparatus 10 is securely fastened to the cabinetry. While wood screws provide a secure connection and flat surfaces for flush mounting, other fasteners are also contemplated in this embodiment. The screw hole 21 can be countersunk in different configurations to accept various fasteners while still providing a flush bottom surface for the horizontal wall 22. Various screws, nails, tacks or pins may be applied through the screw hole 21 in order fasten the clip 33 and the leveling apparatus 10 to the object to be leveled.

It should be appreciated that in one non-limiting embodiment the clip 33 is dimensioned for a friction fit around the bottom edge 32 of the cabinetry 30. While the fasteners is not necessary to keep the bottom edge 32 of the cabinetry in the channel 8, it provides are particular advantage when cabinetry is turned on its side prior to or during installation.

Fasteners applied through screw hole 21 in conjunction with the tight friction fit previously described ensure each leveling apparatus 10 is securely affixed to the objects for leveling. In one non-limiting embodiment, the channel 8 may be slightly wider to accommodate a variety of bottom edges 32. In this embodiment, several sized bottom edges 32 would freely slide into and out of the channel 8. Lacking the inference fit previously described, each leveling apparatus 10 would be secured solely by a fastener through screw hole 21.

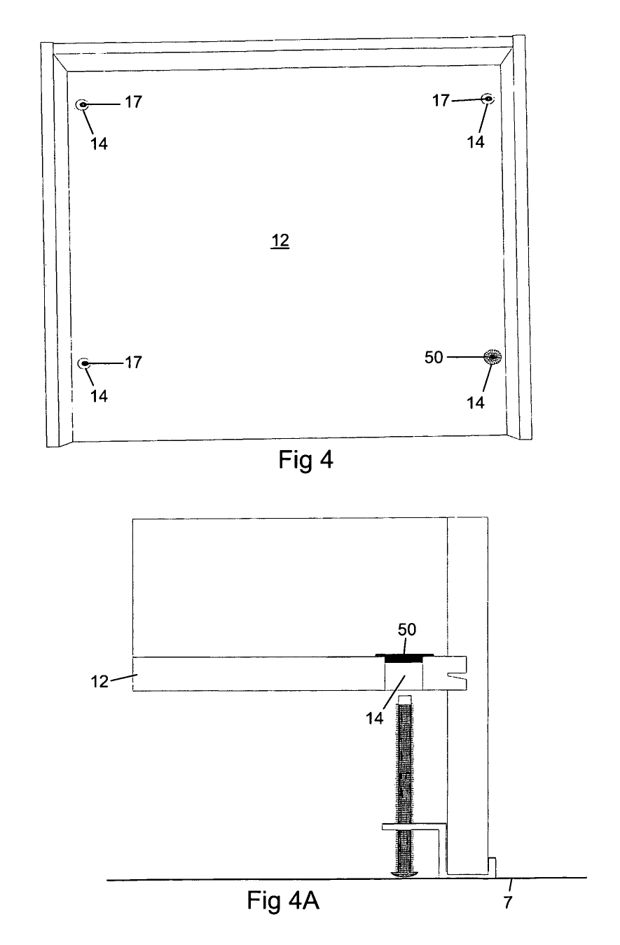

Referring now to FIG. 3, leveling apparatus 10 is attached to cabinet or enclosure 30 with bottom wall end 32 set into channel 8. The leveling apparatus 10 is further positioned such that the threaded member 13 is aligned with hole 14 formed in lower shelf or cabinet sub-floor 12. It should be appreciated that threaded member 13 preferably does not extend through hole 14 into the interior of cabinet or enclosure 30, thus, preventing any interference between threaded member 13 and any objects which may be stored in cabinet or enclosure 30. Hole 14 may be left open or may be capped from the interior of enclosure 30. It should be appreciated that the capping of hole 14 may be through the use of a plug or cover which is configured to fit on or into hole 14. It should be further appreciated that cover or plug 50 (see FIG. 4) may be of any suitable material and color which would preferably blend in well with cabinet or enclosure 30. It should be appreciated that such a configuration may allow leveling of a cabinet or enclosure which has shifted or moved after instillation, for reasons such as but not limited to, the shifting of a house or other structure or land. Thus, the cabinet or enclosure 30 can be leveled without substantial reconstruction.

In operation, leveling apparatus 10 is preferably installed when individual cabinet units or walls can either be put in an upside down position or be easily lifted for insertion of cabinet bottom end 32 into channel 8. In a typical installation, four of the leveling apparatuses 10 should be installed in the four corners. However as described herein above, different geometric shapes of cabinetry may require more or fewer leveling apparatus 10. It should be noted that the present leveling apparatus 10 provides an advantage in that it does not necessarily need to be located at or near a corner. Rather, leveling apparatus 10 is free to be placed where ever necessary to support the weight of the object to be leveled. However, regardless of the number of apparatuses 10 installed, each leveling apparatus 10 should be installed interior to the space formed by cabinet walls 40 and bottom shelf or sub-floor 12 (i.e., underneath shelf 12). After the leveling apparatus 10 has been attached to the bottom side 32 of cabinet wall 40, hole 14 should be drilled in sub-floor or bottom shelf 12, as illustrated in FIGS. 1 and 3, directly above the threaded member 13. The hole 14 should be of a diameter sufficient to allow the passing of a tool which would be able to rotate threaded member 13. After the cabinet has been placed in an upright position and/or leveling apparatuses 10 have been attached and hole 14 has been drilled, the cabinetry may be leveled. It should be appreciated that hole 14 may be pre-drilled in the bottom shelf of sub-floor 12 prior to the installation of the leveling apparatus 10. In such a case, it is obvious to those skilled in the art that the leveling apparatus 10 must be aligned so as to provide access to top end 17 (FIG. 2) through the hole 14. FIGS. 2 and 3 illustrate a leveling tool 20 which may access threaded member 13. However, it should be appreciated that leveling tool 20 is preferably used in the installation or construction stage of the cabinetry and may not be configured for access when cabinets are been previously installed. Preferably, each leveling apparatus 10 is accessible by a rotational tool and threaded member 13 can be turned in a clockwise or counterclockwise direction to extend or retract bottom end 15 toward or away from the support surface 7 upon which cabinet or enclosure 30 is set. The exact technique of leveling the cabinets should be well known in the industry so that the surfaces are substantially level to prevent spillage or dropping of any objects placed upon such cabinet 30 and such leveling techniques will not be detailed herein. After each leveling apparatus 10 has been set in a preferred position, thus leveling the cabinetry 30, the cabinetry 30 can then be either more permanently attached to the support structure or to a wall, or may be left as desired. It should be noted that if the cabinetry is not permanently attached to the structure which supports said wall or other surrounding structure, the leveling apparatuses can be utilized at later dates to maintain levelness of cabinetry 30 regardless or other structure movement or settling. However, even if more permanently attached, future detachment will allow the use of the leveling apparatus 10.

It should be appreciated that alternative embodiments of the leveling apparatus are envisioned which are clearly within the scope of the present invention. For example, the attachment clip 33 could be modified to allow attachment of the leveling apparatus of 10 to the inside of a wall 40. Preferably, plate 18 will still comprises threaded hole 4 through which threaded member 13 may pass. However, horizontal wall 22 preferably extends in a perpendicular direction and away from the cabinet 30 support or floor 7. A hole may be formed through horizontal wall 22 for attachment to cabinet wall 40. FIG. 1 and FIG. 3 illustrate the leveling apparatus 10 is then preferably attached to align threaded member 13 with hole 14, which is formed in bottom shelf or sub-floor 12. After leveling apparatus 10 has been attached to wall 40, threaded member 13 can be turned by applying a rotational tool to top end 17, and allow threaded member to advance through threaded hole 4 until contact is made with a surface or floor 7 supporting cabinet 30. Further turning of threaded member 17 will lift cabinet 30 and such described mounting and turning of other leveling apparatus 10 will allow the cabinet to be leveled.

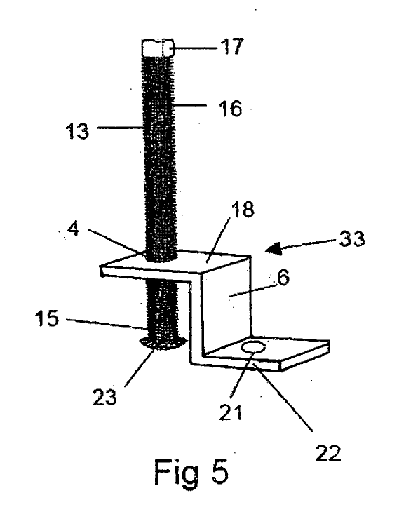

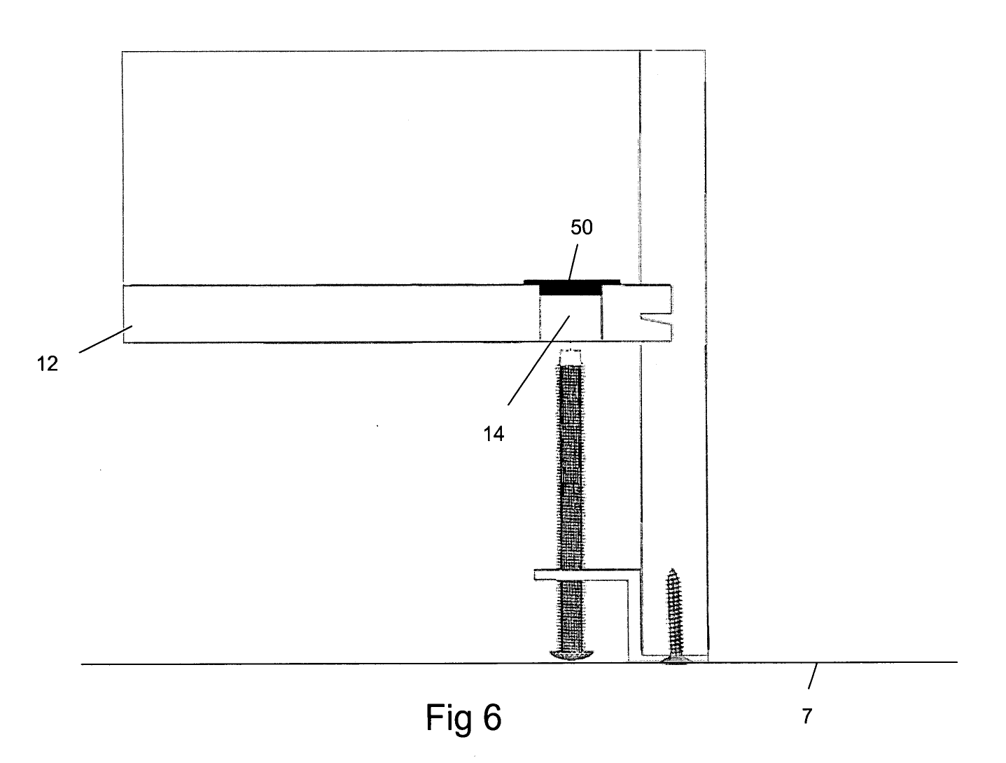

FIG. 5 illustrates a non-limiting embodiment of the present invention in which upright wall 5 has been removed in order to accommodate cabinetry edges 32 of differing thicknesses. In this configuration, there is no longer a channel 8. Rather the bottom edge 32 of cabinetry rests on horizontal wall 22. Once cabinetry 40 is in place this configuration provides sufficient support for the devices leveling function. In this configuration screw hole 21 is required to provided access to the bottom edge 32 of the cabinetry 40 for securing clamp 33 with a fastener (which can be seen in FIG. 6). The fastener serves to keep clamp 33 in place even when cabinetry is lifted or turned on its side. Some prior art devices incorporate screws into the side of cabinetry 40 in order to affix the leveling device to the cabinetry 40. For example see U.S. Pat. No. 4,202,083, which is incorporated herein by reference. In this prior art configuration, a substantial portion of the cabinetry's weight is being supported by these screws and/or the cabinet floor or bottom self. The stress at these locations may cause wear and become destructive to certain cabinetry materials, such as particle board. The present application avoids these down falls by including a screw hole 21 in the horizontal wall 22. In this configuration the fastener keeps the leveling apparatus 10 secured to cabinetry 40 when the cabinetry 40 is moved or turned, but the fastener does not support the weight of the cabinetry 40. Instead, the weight of the cabinetry falls on the flat surface of horizontal wall 22. Distributing the cabinets weight, or a portion of the cabinets weight, over a larger area reduces wear on the bottom edge 32 of the cabinet. Counter sinking screw hole 21 allows the clamp 33 to accommodate a fastener and the bottom surface of horizontal wall 22 to rest flush against a surface such as a floor. In this way the fastener secures clamp 33 to the cabinetry 40, but does not bear the load of the cabinets weight. The weight of the cabinet is still placed on horizontal wall 22. Prior art devices required multiple fasteners in the side of the device to distribute the cabinets weight, the current configuration only requires a single fastener which produces less wear on cabinetry and provides for faster installation.

It will be understood that certain features and sub-combinations are of utility and may be employed without reference to other features and sub-combinations. This is contemplated by and is within the scope of the claims. It may be seen from the preceding description that an apparatus for leveling has been provided. Although specific examples may have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. An apparatus for establishing and/or maintaining a position of a desired object on a support surface comprising:
a clamp member attachable to the desired object, said clamp member comprising a first arm defining a single opening, a substantially flat second arm essentially parallel to said first arm, a transverse member extending between said first arm and said second arm, and a gripping piece extending transverse from said second arm and attached to said second arm at a position distal to said transverse member, wherein said transverse member, said second arm, and said gripping piece form a flat-bottom channel to grip onto a single bottom edge of the desired object, wherein the flat-bottom channel is dimensioned for an interference fit with the bottom edge of the desired object to prevent the clamp member from sliding off the bottom edge; and
a one piece threaded member threadedly engaged only with said single opening of said first arm, said one piece threaded member having a top end and bottom portion with a rounded or spherical bottom surface wherein said rounded or spherical bottom surface is configured to contact the support surface, and wherein said top end is configured to be rotated, rotation of said threaded member causing the desired object to move toward or away from the support surface for positioning as desired, and wherein said rotation and/or positioning capability remain adjustable while said apparatus bears the weight of said desired object, and wherein said threaded member can be positioned to allow said clamp member second arm to directly contact the support surface.

2. The apparatus of claim 1 wherein the object has a sub-floor and/or a bottom shelf, the apparatus further comprising:
an adjusting tool for mating with the threaded member top end for adjusting the threaded member,
wherein said top end of said threaded member is accessible only through an opening in the sub-floor and/or the bottom shelf in the desired object, for adjusting the position of the object when the object is located in its functional location.

3. The apparatus of claim 1 further comprising a hole counter sunk into the second arm allowing for receiving a fastening device therethrough to fasten the clamp onto the object, while allowing the second arm to make flush contact with the support surface.

4. The apparatus of claim 1 wherein the round or spherical bottom surface of the one piece threaded member provides a self seating interface with the support surface.

5. The apparatus of claim 1 wherein the clamp member is firmly gripped onto the bottom edge of an object to be leveled without the use of fasteners that penetrate the object or the support surface.

6. The apparatus of claim 1 wherein the top end has a top cross-section substantially polygonal shaped, or is configured to accept a flathead screwdriver, or is configured to accept a cross head screw driver, or is configured to accept an hexagonal tool wrench, or is configured to accept a torx head tool.

7. An apparatus for establishing and/or maintaining a position of a desired object on a support surface, the object having a sub-floor and/or bottom shelf, the apparatus comprising:
a first member, configured to be attached to the desired object,
a fastener that penetrates the object or support surface to which the first member is attached;
said first member comprising a first wall and a second wall substantially in parallel and a bottom wall forming a substantially flat bottom channel between said first wall and said second wall, wherein the flat bottom channel is dimensioned for an interference fit with a bottom edge of the desired object to prevent the clamp member from sliding off the bottom edge;
a one piece second member; said first member defining a single opening for engaging the one piece second member;
the one piece second member having two ends, wherein a first end, having a rounded or spherical bottom, is configured to contact the support surface, and wherein a second end is configured for operational engagement with an adjusting tool, whereby said operational engagement of said one piece second member will cause said one piece second member to extend or retract toward or away from the support surface, thus positioning at least part of the desired object where desired, and wherein said second member can be positioned to allow said first member to directly contact the support surface and wherein said positioning remains adjustable while said first member and said one piece second member bear the weight of said desired object; and
an adjusting tool for mating with said one piece second member first end for adjusting the one piece second member, wherein said first end of said one piece second member is accessible through an opening in the sub-floor and/or the bottom shelf in the desired object, for adjusting the position of the object when the object is located in its functional location.

8. The apparatus of claim 7 wherein said first member is mounted on a bottom side of the desired object.

9. The apparatus of claim 7 wherein the end configured for operational engagement is configured to be rotated.

10. The apparatus of claim 7 wherein said first member comprises a first flange member and a second flange member mounted substantially transverse to said first flange member and wherein said second flange member may be mounted to the desired object.

11. The apparatus of claim 7 wherein the top end has a top cross-section substantially polygonal shaped, or is configured to accept a flathead screwdriver, or is configured to accept a cross head screw driver, or is configured to accept an hexagonal tool wrench, or is configured to accept a torx head tool.

12. An apparatus for adjusting and/or maintaining an object level on a supporting surface comprising:
a first member comprising:
a first substantially flat portion defining a hole;
a second substantially flat portion substantially parallel to the first substantially flat portion;
a first substantially flat transverse portion connected at one end to the first substantially flat portion and at the opposite end to the second substantially flat portion and substantially perpendicular to both the first and second substantially flat portions; and
a second substantially flat transverse portion substantially parallel to the first substantially flat transverse portion and connected to the end of the second substantially flat portion opposite the end which is connected to the first substantially flat transverse portion;
wherein the first substantially flat transverse portion, the second substantially flat transverse portion and the second substantially flat portion form a flat bottom channel to receive the bottom edge of an objected to be leveled, wherein the flat bottom channel is dimensioned for an interference and/or friction fit with the bottom edge of the object to be leveled, and wherein the hole defined by the first substantially flat portion is threaded; and
a second member comprising;
a top portion configured to be rotated;
a body, wherein the body is threaded and threadably engaged through the hole in first substantially flat portion, wherein rotation of the body moves the first member towards or away from the support surface; and
a substantially rounded or spherical bottom surface, wherein rotation of the second member seats the bottom surface on the support surface, wherein the bottom surface is sized to allow the second substantially flat portion to directly contact the support surface; wherein rotation of the second member displaces the first member and the bottom edge of the object being held in the channel towards or away from the support surface for leveling, wherein the second member is a single piece.

13. The apparatus of claim 12 wherein the object has a sub-floor and/or a bottom shelf, the apparatus further comprising:
an adjusting tool for mating with the threaded member top portion of the second member for adjusting the threaded member,
wherein said top portion of said threaded member is accessible only through an opening in the sub-floor and/or the bottom shelf in the desired object, for adjusting the position of the object when the object is located in its functional location.

14. The apparatus of claim 13 further comprising a cap for covering openings in the subfloor and/or bottom shelf of the object.

15. The apparatus of claim 13 wherein the second substantially flat portion includes a counter sunk hole for receiving a fastener therethrough for fastening the first member to the bottom edge of the object to be leveled.

16. The apparatus of claim 12 wherein the top end has a top cross-section substantially polygonal shaped, or is configured to accept a flathead screwdriver, or is configured to accept a cross head screw driver, or is configured to accept an hexagonal tool wrench, or is configured to accept a torx head tool.

17. An apparatus for adjusting and/or maintaining an object level on a supporting surface comprising:
a first member comprising:
a first substantially flat portion defining a first hole;
a second substantially flat portion substantially parallel to the first substantially flat portion and defining a second hole;
a first substantially flat transverse portion connected at one end to the first substantially flat portion and at the opposite end to the second substantially flat portion and substantially perpendicular to both the first and second substantially flat portions; and
wherein the first substantially flat transverse portion and the second substantially flat portion defining a hole form ledge to receive the bottom edge of an objected to be leveled, wherein the first hole defined by the first substantially flat portion is threaded and the second hole defined by the second substantially flat portion is counter sunk to receive a fastener for securing the first member to a bottom edge of the object to be leveled; and
a second member comprising;
a top portion configured to be rotated;
a body, wherein the body is threaded and threadably engaged through the hole in first substantially flat portion, wherein rotation of the body moves the first member towards or away from the support surface;
a substantially rounded or spherical bottom surface, wherein rotation of the second member seats the bottom surface on the support surface, wherein the bottom surface is sized to allow the second substantially flat portion to directly contact the support surface; wherein rotation of the second member displaces the first member and the bottom edge of the object being held on the ledge towards or away from the support surface for leveling; and
wherein the second member is an integrally formed single piece.
